(19) United States
(12) Patent Application Publication
(10) Pub. No.: US 2024/0266096 A1
(43) Pub. Date: Aug. 8, 2024

(54) Soft Magnetic Powder, Dust Core, Magnetic Element, And Electronic Device

(71) Applicant: SEIKO EPSON CORPORATION, Tokyo (JP)

(72) Inventors: Toshiki SANO, Hachinohe (JP); Yuto OKUDERA, Hachinohe (JP)

(21) Appl. No.: 18/433,581

(22) Filed: Feb. 6, 2024

(30) Foreign Application Priority Data
Feb. 7, 2023 (JP) 2023-016660

(51) Int. Cl. H01F 1/147; B22F 1/065; B22F 3/02; B22F 3/24; B22F 5/10; B22F 9/08; C22C 38/00; C22C 38/34

(52) U.S. Cl. CPC H01F 1/14766; B22F 1/065; B22F 3/02; B22F 3/24; B22F 5/106; B22F 9/082; C22C 38/004; C22C 38/34; B22F 2003/248; B22F 2009/0828; B22F 2301/35; B22F 2998/10; B22F 2999/00; C22C 2202/02

(57) ABSTRACT

A soft magnetic powder contains: Fe as a main component; Si a content of which is 2.5 mass % or more and 7.5 mass % or less; Cr a content of which is 1.0 mass % or more and 10.0 mass % or less; and impurities. A Vickers hardness of a cross section of a particle is 150 or more and 350 or less, and A/B is 2.0 or more and 8.0 or less, where A is a particle diameter [μm] as an equivalent circle diameter of the particle, and B is a crystal grain diameter [μm] as an equivalent circle diameter of a crystal included in the particle.

The present application is based on, and claims priority from JP Application Serial Number 2023-016660, filed Feb. 7, 2023, the disclosure of which is hereby incorporated by reference herein in its entirety.

### BACKGROUND

### 1. Technical Field

The present disclosure relates to soft magnetic powder, a dust core, a magnetic element, and an electronic device.

### 2. Related Art

Japanese Patent Application Laid-Open No. 2021-077894 discloses soft magnetic powder that contains Si in a range of 0.1 to 15 mass %, Cr in a range of 0.1 to 8 mass %, and Fe as the main component. In this FeSiCr-alloy soft magnetic powder, the ratio (Si/Fe) of the atomic concentration of Si to the atomic concentration of Fe at the depth of the 1 nm from the particle surface is 4.5 to 30. Japanese Patent Application Laid-Open No. 2021-077894 also discloses a water atomization method as the method of manufacturing the FeSiCr-alloy soft magnetic powder. The FeSiCr-alloy soft magnetic powder features excellent electrical insulating properties with the saturation magnetization maintained to the same level as that achieved by known techniques.

The water atomization method described in Japanese Patent Application Laid-Open No. 2021-077894 is a method in which molten metal is rapidly cooled with water to be powdered. With the rapid cooling, fine crystal grain diameter can be achieved, but the particle shape is likely to compromised and the fillability is deteriorated. As a result, the magnetic permeability of the compact formed by powder compacting is compromised.

In view of this, soft magnetic powder featuring excellent fillability at the time of compacting and enabling manufacturing a compact featuring high magnetic permeability has been called for.

### SUMMARY

A soft magnetic powder according to an application example of the present disclosure includes
Fe as a main component,
Si contained at 2.5 mass % to 7.5 mass %,
Cr contained at 1.0 mass % to 10.0 mass %, and
impurities, wherein
a Vickers hardness of a cross section of a particle is 150 or more and 350 or less, and
A/B is 2.0 or more and 8.0 or less, where A is a particle diameter [μm] as an equivalent circle diameter of the particle, and B is a crystal grain diameter [μm] as an equivalent circle diameter of a crystal included in the particle.

A dust core according to an application example of the present invention includes the soft magnetic powder according to the application example of the present disclosure.

A magnetic element according to an application example of the invention includes the dust core according to the application example of the present disclosure.

An electronic device according to an application example of the invention includes the magnetic element according to the application example of the present disclosure.

### BRIEF DESCRIPTION OF THE DRAWINGS

FIG. 1 is a plan view schematically illustrating a coil component of a toroidal type.

FIG. 2 is a transparent perspective view schematically illustrating a coil component of a closed magnetic circuit type.

FIG. 3 is a perspective view illustrating a mobile personal computer as an electronic device including a magnetic element according to an embodiment.

FIG. 4 is a plan view illustrating a smartphone as the electronic device including the magnetic element according to the embodiment.

FIG. 5 is a perspective view illustrating a digital still camera as the electronic device including the magnetic element according to the embodiment.

FIG. 6 is an electron micrograph taken of soft magnetic powder that is Sample No. 13 as Comparative Example.

FIG. 7 is an electron micrograph of soft magnetic powder that is Sample No. 6 an Example.

### DESCRIPTION OF EMBODIMENTS

Soft magnetic powder, a dust core, a magnetic element, and an electronic device according to an aspect of the present disclosure will be described in detail below with reference to preferable exemplary embodiments illustrated in accompanying drawings.

### 1. Soft Magnetic Powder

The soft magnetic powder according to the embodiment is a soft magnetic metal powder. The soft magnetic powder can be applied to any use. An example of the application includes manufacturing of various green compacts such as a dust core and an electromagnetic wave absorber, with particles bound to each other via a binder.

### 1.1. Composition

The soft magnetic powder contains iron (Fe) as the main component, and is composed of silicon (Si) the contained at 2.5 mass % to 7.5 mass %, chromium (Cr) the contained at 1.0 mass % to 10.0 mass %, and impurities.

The main component refers to an element having the highest content in terms of atomic ratio. Fe is the main component of the soft magnetic powder and thus has a huge impact on the basic magnetic properties of the soft magnetic powder.

The content of Fe is not limited, but is preferably from 80 mass % or more, and is more preferably 90 mass % or more.

The content of Si is set to 2.5 mass % to 7.5 mass %, but is preferably 2.7 mass % to 5.0 mass %, and is more preferably 3.0 mass % to 4.5 mass %. As long as the content of Si is within the above range, a green compact featuring higher magnetic permeability can be obtained. The content of Si falling below the lower limit value described above leads to compromised magnetic permeability. On the other hand, the content of Si exceeding the upper limit value described above leads to a hard material, plagued by brittle soft magnetic powder particles and/or poor deformability during the compacting.

The content of Cr is set to 1.0 mass % to 10.0 mass %, but is preferably 3.0 mass % to 6.0 mass %, and is more preferably 4.0 mass % to 5.0 mass %. As long as the content of Cr is within the above range, the oxidation resistance of the soft magnetic powder can be enhanced. Thus, the soft magnetic powder in which the occupancy of the oxide is suppressed to be particularly low at the time of compacting is obtained. The content of Cr falling below the lower limit value described above leads to the soft magnetic powder with compromised oxidation resistance. The content of Cr exceeding the above upper limit value leads to compromised magnetic properties such as magnetic permeability.

Further, the soft magnetic powder may contain at least one of carbon (C) and sulfur (S).

The content of C is preferably 0.0200 mass %, is more preferably 0.0050 mass % to 0.0200 mass %, and is even more preferably 0.0070 mass % to 0.0150 mass %. The content of C affects the viscosity of the melt as a result of melting the raw material of the soft magnetic powder. Specifically, when the content of C is within the range described above, the particle shape of the soft magnetic powder can be made closer to a spherical shape. Thus, the soft magnetic powder facilitating an increase in the density of the green compact is obtained. The content of C may fall below the lower limit value described above, but with such a content, the effect of making the particle shape spherical may not be sufficiently obtained, depending on the composition of the soft magnetic powder. On the other hand, when the content of C exceeds the upper limit value described above, the composition balance of the soft magnetic powder is compromised, and the magnetic permeability of the soft magnetic powder may be compromised.

The content of S is preferably 0.0070 mass %, more preferably 0.0020 mass % to 0.0070 mass %, even more preferably 0.0030 mass % to 0.0060 mass %, particularly preferably 0.0040 mass % to 0.0050 mass %. The content of S affects the oxygen content and the particle shape of the soft magnetic powder. Specifically, the oxygen content of the soft magnetic powder tends to be proportional to the content of S. The particle shape changes depending on the content of S. When the content of S is within the range described above, the oxygen content of the soft magnetic powder can be adjusted to an optimum range, and the particle shape can be made closer to a spherical shape. The content of S may fall below the lower limit value described above, but such a content may lead to an excessively low oxygen content of the soft magnetic powder, depending on the composition of the soft magnetic powder. As a result, the insulation between the particles of the soft magnetic powder may be compromised, and the withstand voltage of the green compact obtained by compacting the soft magnetic powder may be lowered. Furthermore, the effect of making the particle shape of the soft magnetic powder spherical may not be sufficiently obtained. On the other hand, the content of S exceeding the upper limit value described above may lead to excessively high oxygen content of the soft magnetic powder. As a result, the occupancy of the oxide the green compact obtained by compacting the soft magnetic powder becomes high, and the magnetic properties such as magnetic permeability may be compromised.

The soft magnetic powder may contain other elements as impurities in addition to the above-described elements. The other elements may be elements inevitably mixed or elements intentionally added.

The concentration each element as the impurity is preferably 0.10 mass %, more preferably 0.05 mass %. The total concentration of the impurities is preferably 1.00 mass %. As long as the impurities are in this range, even if other elements are contained, the effect exhibited by the soft magnetic powder is not affected. Thus, the other elements can be contained.

The soft magnetic powder according to the embodiment may further contain oxygen. Oxygen may be mixed in a raw material or in a manufacturing process. The oxygen content of the soft magnetic powder is preferably 0.30 mass % or less, more preferably 0.20 mass % or less, and even more preferably 0.15 mass % or less. With such a range, the deterioration of the particle shape due to oxygen mixed is suppressed. Thus, the soft magnetic powder featuring a high fillability at the time of compacting can be obtained. Furthermore, a decrease in magnetic permeability due oxygen mixed can be suppressed. While the lower limit value may not be set, some amount of oxygen may be mixed, for guaranteeing the insulation between particles. The lower limit value of the oxygen content is preferably 0.03 mass % or more, more preferably 0.05 mass % or more, and even more preferably 0.08 mass % or more. With this configuration, it is possible to obtain a green compact in which sufficient insulation between particles can be guaranteed and eddy current loss is suppressed.

The above compositions are identified by the following analysis method.

Examples of the analysis method include iron and steel-atomic absorption spectrometry defined in JIS G 1257: 2000, iron and steel-ICP emission spectrometry defined in JIS G 1258: 2007, iron and steel-spark discharge emission spectrometry defined in JIS G 1253:2002, iron and steel-X-ray fluorescence spectrometry defined in JIS G 1256: 1997, weight-titration-absorptiometry defined in JIS G 1211 to G 1237 and the like.

Specifically, a solid emission spectrometer manufactured by SPECTRO Analytical Instruments, in particular, a spark discharge emission spectrometer, model: SPECTROLAB, type: LAVMB08A, and an ICP device CIROS120 type manufactured by Rigaku Corporation may be used for example.

In particular, an oxygen stream combustion (high-frequency induction heating furnace combustion)-infrared absorption method defined in JIS G 1211: 2011 is also used for the identification of carbon (C) and sulfur (S). Specifically, a carbon/sulfur analyzer CS-200 manufactured by LECO Corporation may be used.

Further, in particular, iron and steel-nitrogen quantification method defined in JIS G 1228:1997 and the general rule of oxygen quantification method for metallic materials defined in JIS Z 2613:2006 are used for identifying nitrogen (N) and oxygen (O). Specifically, an oxygen-nitrogen analyzer manufactured by LECO, TC-300/EF-300, an oxygen-nitrogen-hydrogen analyzer manufactured by LECO, ONH836, and the like may be used.

### 1.2. Powder Properties

An equivalent circle diameter of a particle of the soft magnetic powder is defined as a particle diameter A [μm], and an equivalent circle diameter of a crystal included in the particle is defined as a crystal grain diameter B [μm].

For the soft magnetic powder according to the embodiment, A/B is preferably set to be 2.0 or more and 8.0 or less, more preferably set to be 3.0 or more and 6.5 or less, and even more preferably set to 3.5 or more and 5.5 or less. When A/B is within the range described above, the ratio of the crystal grain diameter B to the particle diameter A is within a predetermined range, and thus the crystal grain diameter B is prevented from being excessively small with respect to the particle diameter A. Thus, excessive increase in the surface hardness of the particles can be prevented, and soft magnetic powder which may be slightly deformed at the time of compacting can be obtained. As a result, soft magnetic powder featuring a high fillability at the time of compacting is obtained.

The fillability at the time of compacting also affects the magnetic permeability of the green compact. Therefore, by using the soft magnetic powder with A/B being within the range described above, the crystal grain diameter B is likely to be appropriate, whereby a green compact featuring high magnetic permeability can be manufactured.

A/B falling below the lower limit value described above means that the particle diameter A is too small relative to the crystal grain diameter B. This leads to a large specific surface area of the soft magnetic powder, resulting in compromised fluidity and compromised fillability at the time of compacting. Furthermore, this leads to high oxygen content, resulting in compromised magnetic permeability of the green compact. On the other hand, A/B exceeding the upper limit value described above means that the crystal grain diameter B is excessive small relative to the particle diameter A. This leads to a sharp increase in the surface hardness of the particles, resulting in compromised fillability of the soft magnetic powder at the time of compacting.

The crystal grain diameter B is preferably 4.0 μm or more and 18.0 μm or less, more preferably 5.0 μm or more and 15.0 μm or less, and even more preferably 6.0 μm or more and 13.0 μm or less. When the crystal grain diameter B is within the range described above, the surface hardness of the particles can be optimized to such an extent that slight deformation occurs at the time of compacting, and the magnetic permeability of the soft magnetic powder can be sufficiently increased.

The crystal grain diameter B falling below the lower limit value described above may lead to high surface hardness of the particles and compromised magnetic permeability of the soft magnetic powder. The crystal grain diameter B exceeding the upper limit value described above may lead to an increased difficulty of the manufacturing of the soft magnetic powder.

The particle diameter A and the crystal grain diameter B are measured as follows.

First, the soft magnetic powder is buried in resin to prepare a molded product for analysis. Next, the surface of the molded product for analysis is polished to expose a cross section of the particle. Next, an image (secondary electron image) of the cross section of the particle is captured using a scanning electron microscope (SEM). Next, image processing software reads the captured image. As the image processing software, for example, image analysis type particle size distribution measurement software “Mac-View” manufactured by Mountech Co., Ltd. or the like is used. The imaging magnification is adjusted to make one image include 50 to 100 particles.

Then, the equivalent circle diameter of each particle image is obtained as the particle diameter A. The equivalent circle diameter of the particle image is the diameter (Heywood diameter) of a circle having the same area as the area of the particle image (projected area of the particle).

The equivalent circle diameter of each crystal grain image is obtained as the crystal grain diameter B. The equivalent circle diameter of the crystal grain image is the diameter (Heywood diameter) of a circle having the same area as the area of the crystal grain image. Corrosion treatment may be performed on the cross section before the crystal grain image is captured. Thereby, the crystal grain diameter can be corroded, whereby the contrast of the crystal grain image is improved.

The above-described value of A/B is an average value of 100 or more A/B values calculated from the results obtained by determining the particle diameter A and the crystal grain diameter B for 10 or more particles and 10 or more crystals contained in each of the particles. In other words, A/B may be obtained as an average of 100 or more values of A/B calculated based on the particle diameter A of each particle and the crystal grain diameter B of the crystal included in the particle. The crystal for which the crystal grain diameter B is to be obtained may be selected at random.

The average particle diameter of the soft magnetic powder, which is not particularly limited, is preferably 1.0 μm or more and 20.0 μm or less, more preferably 3.0 μm or more and 15.0 μm or less, and even more preferably 5.0 μm or more and 12.0 μm or less. Thus, soft magnetic powder featuring high fillability at the time of compacting and enabling suppression of eddy current loss in the green compact can be obtained.

The average particle diameter of the soft magnetic powder falling below the lower limit value described above, may lead to a higher chance of aggregation of the soft magnetic powder resulting in compromised green compact density, depending on the particle size distribution of the soft magnetic powder. On the other hand, the average particle diameter of the soft magnetic powder exceeding the upper limit value described above may lead to an increased eddy current loss of a green compact obtained by compacting the soft magnetic powder, depending on the particle size distribution of the soft magnetic powder.

The average particle diameter refers to a particle diameter D50 corresponding to the cumulative frequency of 50% from the small diameter side in the volume-based cumulative particle size distribution of the soft magnetic powder, obtained using a laser diffraction-type particle size distribution measuring device.

The average particle diameter of the soft magnetic powder is defined as α [μm], and the oxygen content is defined as β [mass %]. With such definition, α×β is preferably 0.6 or more and 1.8 or less, more preferably 0.8 or more and 1.5 or less, and even more preferably 1.0 or more and 1.4 or less. As long as α×β is within the above range, soft magnetic powder featuring a good balance between the particle diameter and the oxygen content can be obtained. That is, the soft magnetic powder with α×β being within the above range can have a small oxygen content even when the diameter is relatively small, and thus may be power that is compacted into a green compact featuring high magnetic permeability and low iron loss.

When α×β falls below the lower limit value described above, aggregation may be likely to occur due to an excessively small diameter of the soft magnetic powder, and the insulation may be compromised due to insufficient oxygen content. On the other hand, when α×β exceeds the upper limit value described above, the eddy current loss may increase due to an excessively large particle diameter of the soft magnetic powder, and the magnetic permeability may be compromised due to excessive oxygen content.

The average circularity of the soft magnetic powder is preferably 0.60 or more, more preferably 0.70 or more and 1.00 or less, and even more preferably 0.85 or more and 0.95 or less. With this configuration, soft magnetic powder featuring particularly high fillability at the time of compacting is obtained. Furthermore, an insulating film can be formed on the particle surface of the soft magnetic powder, formed uniformly, that is, without unevenness. Thus, the green compact with excellent insulation between particles can be manufactured.

The average circularity falling below the lower limit value described above may result in compromised fillability of the soft magnetic powder at the time of compacting. Furthermore, uniformity of the thickness of the insulating film may be compromised. On the other hand, the average circularity may be higher than the upper limit value described above, but such circularity may increase production difficulty may.

The average circularity of the soft magnetic powder is measured as follows.

First, an image (secondary electron image) of the soft magnetic powder is captured using a scanning electron microscope (SEM). Next, image processing software reads the captured image. As the image processing software, for example, image analysis type particle size distribution measurement software “Mac-View” manufactured by Mountech Co., Ltd. or the like is used. The imaging magnification is adjusted to make one image include 50 to 100 particles. Then, a plurality of the images are acquired so as to obtain a total of 300 or more particle images.

Next, using software, the circularities of 300 or more particle images are calculated and an average value is obtained. The average value is obtained as the average circularity of the soft magnetic powder. This circularity defined as e is obtained by the following equation, where S represents the area of the particle image, and L represents the perimeter of the particle image.

e=4πS/L²

The Vickers hardness of the cross section of the particle of the soft magnetic powder is 150 or more and 350 or less, preferably 200 or more and 300 or less. When the Vickers hardness of the particle cross section is within the above range, the particle surface is likely to be deformed appropriately when the soft magnetic powder is compacted. Thus, the fillability at the time of compacting of the soft magnetic powder can be improved. The Vickers hardness falling below the lower limit value described above leads to a higher risk of excessive deformation of the particle surface, resulting in unintended deformation when the soft magnetic powder is classified or an insulating film is formed for example. On the other hand, the Vickers hardness exceeding the upper limit value described above leads to the particle surface that is less likely to deform, resulting in compromised fillability of the soft magnetic powder at the time of compacting.

The Vickers hardness of a particle cross section is measured as follows.

First, the cross section of the particle is exposed and observed using an optical microscope. Next, the Vickers hardness at the center of the cross section is measured by a hardness tester. A Vickers hardness meter is used as the hardness tester. The measurement load is 5 kgf (49 N), and the load holding time is 10 seconds.

The specific surface area of the soft magnetic powder is preferably 0.20 m²/g or more and 0.45 m²/g or less, more preferably 0.25 m²/g or more and 0.40 m²/g or less, and even more preferably 0.28 m²/g or more and 0.36 m²/g or less. As long as the specific surface area is within the above range, the fillability of the soft magnetic powder is improved, and the green compact with high density can be obtained. When the specific surface area falls below the lower limit value described above, the particle diameter of the soft magnetic powder may be excessively large. On the other hand, the specific surface area exceeding the upper limit value described above leads to compromised fillability of the soft magnetic powder, resulting in a green compact with a low density.

The specific surface area is obtained by the BET method. Examples of the specific surface area measuring device include a BET specific surface area measuring device HM1201-010 manufactured by Mountech Co., Ltd., and the amount of the sample is 5 g.

### 1.3. Insulating Film

An insulating film may be provided at the surface of the particles of the soft magnetic powder as necessary. By providing such an insulating film, the insulation between the particles of the soft magnetic powder can be improved. As a result, the eddy current flowing between the particles can be suppressed, whereby the eddy current loss in the green compact can be suppressed.

For example, a glass material, a ceramic material, a resin material, or the like may be used for the insulating film.

### 1.4. Magnetic Permeability

The soft magnetic powder according to the embodiment has a magnetic permeability of preferably 35.3 or more, more preferably 35.5 or more, and even more preferably 36.0 or more at the measurement frequency of 100 kHz, when compacted into the green compact. With the soft magnetic powder, a green compact featuring high magnetic permeability can be obtained.

The magnetic permeability of the green compact is, for example, a relative magnetic permeability obtained from a self-inductance of a closed magnetic circuit magnetic core coil, with the green compact having a toroidal shape, and thus is an effective magnetic permeability. For the measurement of the magnetic permeability, an impedance analyzer is used with the measurement frequency of 100 KHz. The number of turns of the winding is 7, and the wire diameter of the winding is 0.6 mm. The green compact has a size defined by an outer diameter of φ 14 mm, an inner diameter of φ 8 mm, and a thickness of 3 mm, and the compacting force is 294 MPa.

### 2. Method of Manufacturing Soft Magnetic Powder

Next, an example of a method of manufacturing the soft magnetic powder described above will be described.

The soft magnetic powder may be powder manufactured by any method. Examples of the manufacturing method include various atomization methods such as a water atomization method, a gas atomization method, and a rotating water flow atomization method, as well as a pulverization method and the like for example. Powder manufactured by the atomization method, among the methods, is preferably used as the soft magnetic powder. With the atomization method, it is possible to efficiently manufacture a high-quality metal powder with a particle shape closer to a true sphere and less formation of oxides and the like. Thus, metal powder with a smaller specific surface area can be manufactured by the atomization method.

The atomization method is a method in which molten metal collides with liquid or gas injected at a high speed to be atomized and then is cooled, whereby metal powder is manufactured. In the atomization method, the molten metal is atomized and then spheroidized during the solidification, so that particles closer to a true sphere can be produced.

The water atomization method is a method of manufacturing metal powder from molten metal by using a liquid such as water as a cooling liquid. In the method, the liquid is injected in an inverted conical shape so as to converge at one point, and the molten metal flows down toward the converging point, to collide with the liquid.

The rotating water flow atomization method is a method of manufacturing metal powder in which cooling liquid is supplied along the inner circumference surface of a cooling cylinder to swirl along the inner circumference surface, liquid or gas jet is blown onto molten metal, and the resultant scattered molten metal is received in the cooling liquid.

The gas atomization method is a method of manufacturing metal powder from molten metal by using gas as a cooling medium. In the method, the gas is injected to be in an inverted conical shape converging at one point, and the molten metal flows downward toward the converging point to collide with the gas at the converging point.

With the atomization methods, the parameters such as A/B, α×β, and average circularity of particles can be adjusted in accordance with the casting temperature of the molten metal.

The casting temperature of the melting temperature is preferably set to be higher than Tm+200° ° C., more preferably set to be Tm+220° C. or higher and Tm+350° C. or lower, and more preferably set to be Tm+250° C. or higher and Tm+300° ° C. or lower, where Tm [° C.] is the melting point of the constituent material of the soft magnetic powder. With this configuration, a longer time during which the molten metal exists as the molten metal before being atomized and solidified by various atomization methods can be secured compared with known cases. Thus, the crystal grain diameter B can be adjusted to an appropriate size, and the above-described parameters can be optimized.

The casting temperature lower than the lower limit value described above may lead to a difficulty in reduction of the particle diameter A and the average particle diameter α. Furthermore, the crystal grain diameter B may be excessively small. On the other hand, the casting temperature may be higher than the upper limit value described above, but such temperature may lead to an excessively small particle diameter A and average particle diameter α or an excessively large crystal grain diameter B.

In the atomization method, molten metal flows down through a narrow opening and the resulting streamlet of the molten metal collides with a fluid jet. The outer diameter of the streamlet of the molten metal, which is not particularly limited, is preferably 3.0 mm or less, more preferably 0.3 mm or more and 2.0 mm or less, and even more preferably 0.5 mm or more and 1.5 mm or less. With this configuration, the fluid jet is likely to uniformly collide with the molten metal, whereby droplets of an appropriate size is likely to be uniformly scattered. As a result, the soft magnetic powder having the above-described average particle diameter is obtained. The amount of the molten metal supplied in a certain period of time is reduced, leading to a uniform cooling rate of each droplet, whereby controllability of the crystal grain diameter B is improved.

The soft magnetic powder manufactured may be classified as necessary. Examples of the classification method include dry classification such as sieve classification, inertial classification, and centrifugal classification, and wet classification such as sedimentation classification.

### 3. Dust Core and Magnetic Element

Next, a description will be given on a dust core and a magnetic element according to the embodiment.

The magnetic element according to the embodiment can be applied to various magnetic elements including a magnetic core, such as a choke coil, an inductor, a noise filter, a reactor, a transformer, a motor, an actuator, an electromagnetic valve, and a generator for example. The dust core according to the embodiment can be applied to the magnetic core of these magnetic elements.

Two types of coil components will be representatively described below as examples of the magnetic element.

### 3.1. Toroidal Type

First, a coil component of a toroidal type which is an example of the magnetic element according to the embodiment will be described.

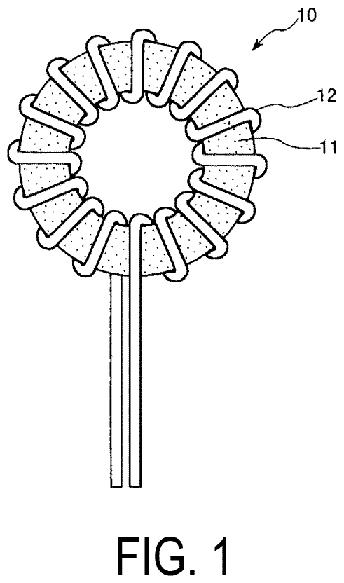

FIG. 1 is a plan view schematically illustrating a coil component of a toroidal type.

A coil component 10 illustrated in FIG. 1 includes a ring-shaped dust core 11 and a conductive wire 12 wound around the dust core 11. Such a coil component 10 is generally referred to as a toroidal coil.

The dust core 11 is obtained by mixing the soft magnetic powder according to the embodiment with a binder, supplying the obtained mixture to a molding die, and pressing and molding the mixture. Therefore, the dust core 11 is a green compact containing the soft magnetic powder according to the embodiment. The dust core 11 features high magnetic permeability and low iron loss even if the soft magnetic powder having a small diameter is used, because the fillability is high. Therefore, an electronic device or the like including the coil component 10 can have a high performance and a small size.

Examples of the constituent material of the binder used for preparing the dust core 11 include organic materials such as silicone-based resin, epoxy-based resin, phenol-based resin, polyamide-based resin, polyimide-based resin, and polyphenylene sulfide-based resin; inorganic materials such as phosphates such as magnesium phosphate, calcium phosphate, zinc phosphate, manganese phosphate, and cadmium phosphate, and silicates such as sodium silicate; and the like. Of these, thermosetting polyimide or epoxy-based resins are particularly preferable. These resin materials are easily cured by heating, and are excellent in heat resistance. Therefore, with the materials, the dust core 11 can be easily manufactured, and can have high heat resistance.

The ratio of the binder to the soft magnetic powder, which slightly varies depending on the target magnetic properties and mechanical properties of the dust core 11 to be manufactured, the allowable eddy current loss, and the like, is preferably about 0.3 mass % to 5.0 mass %, more preferably about 0.5 mass % to 3.0 mass %, and even more preferably about 0.7 mass % to 2.0 mass %. Accordingly, it is possible to obtain the coil component 10 having excellent magnetic properties with the particles of the soft magnetic powder sufficiently bound to each other.

If necessary, various additives may be added to the mixture for any purpose.

Examples of the constituent material of the conductive wire 12 include highly conductive materials such as metal materials including Cu, Al, Ag, Au, Ni, and the like. If necessary, an insulating film may be provided at the surface of the conductive wire 12.

The shape of the dust core 11 is not limited to the ring shape illustrated in FIG. 1, and may be, for example, a partially notched ring shape, a shape in which the shape in the longitudinal direction is linear, a sheet shape, a film shape, or the like.

The dust core 11 may contain soft magnetic powder other than the soft magnetic powder according to the above-described embodiment and/or nonmagnetic powder as necessary.

### 3.2. Closed Magnetic Circuit Type

Next, a coil component of a closed magnetic circuit type which is an example of the magnetic element according to the embodiment will be described.

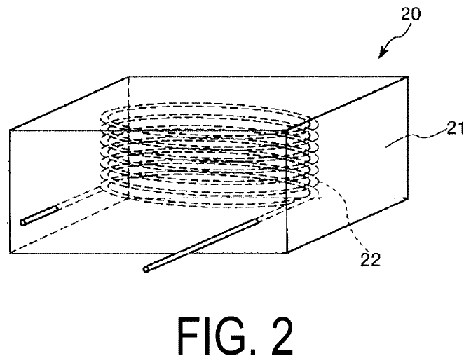

FIG. 2 is a transparent perspective view schematically illustrating the coil component of a closed magnetic circuit type.

The following description on the coil component of the closed magnetic circuit type mainly focuses on differences from the coil component of the toroidal type, and descriptions on similar matters will be omitted.

As illustrated in FIG. 2, a coil component 20 according to the present embodiment is formed by embedding a conductive wire 22 formed in a coil shape inside a dust core 21. In other words, the coil component 20 which is the magnetic element includes the dust core 21 containing the above-described soft magnetic powder, and is formed by molding the conductive wire 22 with the dust core 21. The dust core 21 has the same configuration as the dust core 11 described above. Thus, the coil component 20 featuring excellent magnetic permeability and low iron loss can be obtained.

The coil component 20 having such a configuration can be relatively easily downsized. Therefore, an electronic device or the like including the coil component 20 can have a high performance and a small size.

With the conductive wire 22 embedded in the dust core 21, a gap is less likely to be formed between the conductive wire 22 and the dust core 21. Therefore, vibration due to magnetostriction of the dust core 21 can be suppressed, and generation of noise due to the vibration can also be suppressed.

The shape of the dust core 21 is not limited to the shape illustrated in FIG. 2, and may be a sheet shape, a film shape, or the like.

The dust core 21 may contain soft magnetic powder other than the soft magnetic powder according to the above-described embodiment and/or nonmagnetic powder as necessary.

### 4. Electronic Device

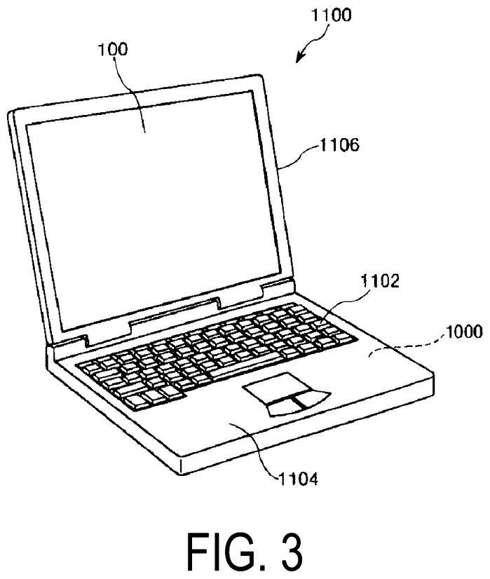

Next, an electronic device including the magnetic element according to the embodiment will be described with reference to FIG. 3 to FIG. 5.

FIG. 3 is a perspective view illustrating a mobile personal computer as an electronic device including the magnetic element according to the embodiment. A personal computer 1100 illustrated in FIG. 3 includes a main body section 1104 including a keyboard 1102 and a display unit 1106 including a display section 100. The display unit 1106 is rotatably supported by the main body section 1104 via a hinge structure section. A magnetic element 1000 such as a choke coil, an inductor, or a motor for a switching power supply is incorporated in the personal computer 1100 for example.

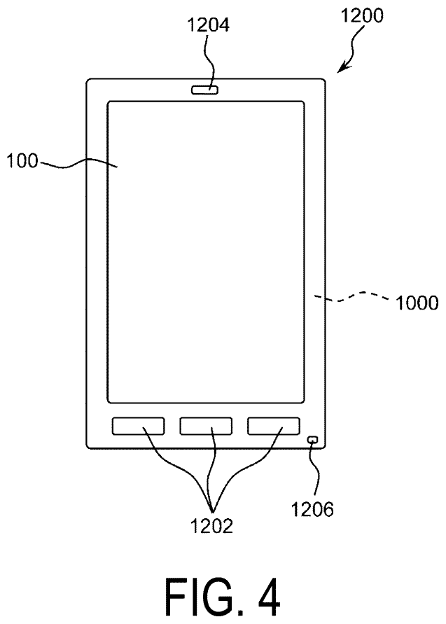

FIG. 4 is a plan view illustrating a smartphone as the electronic device including the magnetic element according to the embodiment. A smartphone 1200 illustrated in FIG. 4 includes a plurality of operation buttons 1202, an earpiece 1204, and a mouthpiece 1206. The display section 100 is disposed between the operation buttons 1202 and the earpiece 1204. The magnetic element 1000 such as an inductor, a noise filter, or a motor is built in the smartphone 1200 for example.

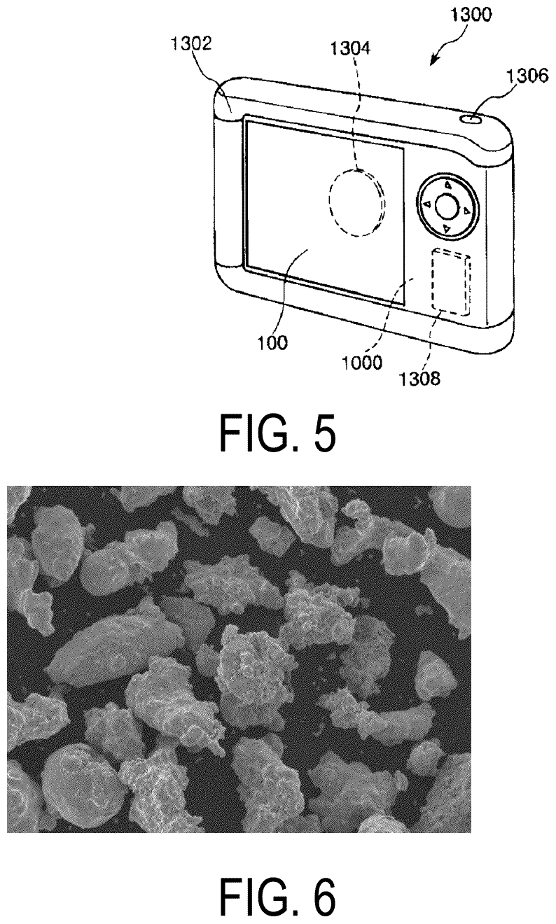

FIG. 5 is a perspective view illustrating a digital still camera which is an electronic device including the magnetic element according to the embodiment. A digital still camera 1300 generates a captured image signal by photoelectrically converting an optical image of a subject using an image sensor such as a charge coupled device (CCD).

The digital still camera 1300 illustrated in FIG. 5 includes the display section 100 provided at the back surface of a case 1302. The display section 100 functions as a finder that displays an electronic image of a subject. A light receiving unit 1304 including an optical lens, a CCD, and the like is provided at the front side of the case 1302, that is, on the back side in the drawing.

When the photographer confirms the subject image displayed on the display section 100 and presses a shutter button 1306, the captured image signal of the CCD at that time is transferred to and stored in a memory 1308. Such a digital still camera 1300 also incorporates the magnetic element 1000 such as an inductor or a noise filter for example.

In addition to the personal computer illustrated in FIG. 3, the smartphone illustrated in FIG. 4, and the digital still camera illustrated in FIG. 5, examples of the electronic device according to the embodiment include a mobile phone, a tablet terminal, a watch, an ink-jet discharge devices such as an ink-jet printer, a laptop personal computer, a television receiver, a video camera, a video tape recorder, a car navigation device, a pager, a videophone, a security television monitor, electronic binoculars, a POS terminal, an electronic thermometer, a sphygmomanometer, a blood glucose meter, an electrocardiogram measuring device, an ultrasonic diagnostic device, a medical device such as an electronic endoscope, a fish finder, various measuring devices, instruments for a vehicle, an aircraft, and a ship, a mobile control devices such as an automobile control device, an aircraft control device, a railroad vehicle control device, and a ship control device, a flight simulator, and the like.

As described above, such an electronic device includes the magnetic element according to the embodiment. Accordingly, it is possible to achieve the effects of the magnetic element according to the embodiment, that is, high magnetic permeability and low iron loss, and to achieve high performance and downsizing of the electronic device.

### 5. Effects of Embodiment

As described above, the soft magnetic powder according to the embodiment is composed of Fe, Si, Cr, and impurities. Fe is the main component. The content of Si is 2.5 mass % to 7.5 mass %. The content of Cr is 1.0 mass % to 10.0 mass %. In the soft magnetic powder according to the embodiment, the Vickers hardness of the cross section of the particle is 150 or more and 350 or less, and A/B is 2.0 or more and 8.0 or less where A is a particle diameter [μm] as the equivalent circle diameter of the particle and B is a crystal grain diameter [μm] as the equivalent circle diameter of the crystal included in the particle.

With such a configuration, since the particle diameter A is prevented from being too small with respect to the crystal grain diameter B or the crystal grain diameter B is prevented from being too small with respect to the particle diameter A, soft magnetic powder featuring high fluidity and appropriate deformability is obtained. Thus, it is possible to obtain soft magnetic powder featuring high fillability at the time of compacting. In addition, it is possible to obtain soft magnetic powder in which the crystal grain diameter B is likely to be appropriate, and enabling manufacturing of a compact featuring high magnetic permeability.

The soft magnetic powder according to the embodiment may contain C contained at 0.0050 mass % to 0.0200 mass %.

With such a configuration, the particle shape of the soft magnetic powder can be made closer to a spherical shape. Thus, the soft magnetic powder facilitating an increase in the density of the green compact is obtained.

In the soft magnetic powder according to the embodiment, α×β is preferably 0.6 or more and 1.8 or less, where α is an average particle diameter and β is an oxygen content.

With such a configuration, it is possible to obtain soft magnetic powder featuring a good balance between the particle diameter and the oxygen content. Such soft magnetic powder can have a small oxygen content even when the diameter is relatively low, and thus may be power that is compacted into a green compact featuring high magnetic permeability and low iron loss.

In the soft magnetic powder according to the embodiment, an average circularity of the particles is preferably 0.60 or more. With this configuration, soft magnetic powder featuring particularly high fillability at the time of compacting is obtained.

A dust core according to the embodiment includes the soft magnetic powder according to the embodiment. Accordingly, a dust core featuring a high fillability of the soft magnetic powder and a high magnetic permeability is obtained. In addition, a dust core easily enabling reduction in iron loss is obtained.

A magnetic element according to the embodiment includes the dust core according to the embodiment. Thus, a magnetic element enabling high performance and downsizing to be easily achieved is obtained.

An electronic device according to the embodiment includes the magnetic element according to the embodiment. As a result, it is possible to achieve high performance and downsizing of the electronic device.

The soft magnetic powder, the dust core, the magnetic element, and the electronic device of the present disclosure have been described above based on the illustrated exemplary embodiments, but the present disclosure is not limited to these. For example, the shapes of the dust core and the magnetic element are not limited to those illustrated in the drawings and may be any shape.

### EXAMPLE

Next, specific examples of the present disclosure will be described.

### 6. Manufacturing of Soft Magnetic Powder

### 6.1. Sample No. 1

First, soft magnetic powder was obtained by the water atomization method. The composition of the obtained soft magnetic powder is as illustrated in Table 1. The conditions for manufacturing the soft magnetic powder by the water atomization method are as illustrated in Table 1.

For the obtained soft magnetic powder, the particle diameter A, the crystal grain diameter B, the average particle diameter α, the oxygen content β, the Vickers hardness, and the circularity were measured. Then, A/B, α×β, and average circularity were calculated from these measured values. The measurement results and calculation results are illustrated in Table 1.

### 6.2. Sample Nos. 2 to 24

Soft magnetic powder was manufactured in the same manner as Sample No. 1 except that the production conditions were changed to those presented in Table 1 or table 2.

In Tables 1 and 2, among types of the soft magnetic powder of the respective sample Nos., those corresponding to the present disclosure referred to as “Example”, and those not corresponding to the present disclosure are referred to as “Comparative Example”.

### 7. Evaluation of Soft Magnetic Powder

### 7.1. Tap Density of Soft Magnetic Powder

The tap density of the soft magnetic powder of each sample No. was measured by the following method.

First, the soft magnetic powder was subjected to a coupling agent treatment. Next, the tap density of the treated soft magnetic powder was measured by a powder characteristic evaluation device. A powder tester (registered trade name) PT-X manufactured by HOSOKAWA MICRON CORPORATION was used as the powder characteristic evaluation device. Phenyltrimethoxysilane was used as the coupling agent.

### 7.2. Density of Green Compact

Using the soft magnetic powder of each sample No., a green compact was manufactured as follows.

First, the soft magnetic powder, epoxy resin (binder), and methyl ethyl ketone were mixed to obtain a mixed material. The amount of the epoxy resin added was 1 mass % with respect to the soft magnetic powder.

Next, the obtained mixed material was stirred, and then heated and dried at a temperature of 150° C. for 30 minutes to obtain a massive dried product. Next, the dried product was passed through a sieve having an opening of 600 μm and pulverized to obtain granulated powder.

Next, the obtained granulated powder was filled in a molding die, and a compact was obtained based on the following molding conditions.
Molding method: press molding
Compact shape: ring shape
Dimensions of compact: outer diameter φ 14 mm, inner diameter φ 8 mm, thickness 3 mm
Compacting force: 294 MPa

Next, the binder in the compact was cured by heating. Thus, a green compact was obtained.

Next, the mass of the obtained green compact was measured, and the density of the green compact was calculated based on the measured mass and the volume of the compact. The calculation results are as illustrated in Table 1 and Table 2.

### 7.3. Magnetic Permeability of Green Compact

The magnetic permeability of the green compact manufactured using the soft magnetic powder of each sample No. was measured by the above-described method. The measurement results are as illustrated in Table 1 and Table 2.

The calculated magnetic permeability was evaluated according to the following evaluation criteria. The evaluation results are as illustrated in Table 1 and Table 2.
A: Magnetic permeability is 36.0 or more.
B: Magnetic permeability is 35.5 or more and less than 36.0.
C: Magnetic permeability is 35.3 or more and less than 35.5.
D: Magnetic permeability is less than 35.3.

TABLE 1

| Configuration of soft magnetic powder | | | | | | | | | |
|---|---|---|---|---|---|---|---|---|---|
| | | | | | Average | | | | |
| | | | | | particle | Oxygen | | | |
| Composition | | | | | diameter | content | α × | Vickers | Average |
| Fe | Si | Cr | C | A/B | α | β | β | hardness | circularity |

| Sample No. | | Mass % | | | — | μm | Mass % | — | — | — |
|---|---|---|---|---|---|---|---|---|---|---|
| No. 1 | Comparative | Remainder | 3.5 | 4.5 | 1.2 | 9.85 | 0.022 | 0.22 | 145 | 0.93 |
| | Example | | | | | | | | | |
| No. 2 | Comparative | Remainder | 3.0 | 4.5 | 1.5 | 9.45 | 0.025 | 0.24 | 150 | 0.93 |
| | Example | | | | | | | | | |
| No. 3 | Comparative | Remainder | 3.5 | 5.5 | 1.8 | 10.20 | 0.030 | 0.31 | 155 | 0.92 |
| | Example | | | | | | | | | |
| No. 4 | Example | Remainder | 3.5 | 4.5 | 2.3 | 10.35 | 0.060 | 0.62 | 178 | 0.93 |
| No. 5 | Example | Remainder | 3.5 | 4.5 | 3.1 | 11.65 | 0.080 | 0.93 | 201 | 0.88 |
| No. 6 | Example | Remainder | 3.5 | 4.5 | 4.2 | 10.54 | 0.115 | 1.21 | 223 | 0.84 |
| No. 7 | Example | Remainder | 3.5 | 4.5 | 4.9 | 10.23 | 0.135 | 1.38 | 247 | 0.80 |
| No. 8 | Example | Remainder | 3.5 | 4.5 | 5.8 | 10.00 | 0.149 | 1.49 | 275 | 0.75 |
| No. 9 | Example | Remainder | 3.5 | 4.5 | 6.9 | 9.85 | 0.168 | 1.65 | 302 | 0.72 |
| No. 10 | Example | Remainder | 3.5 | 4.5 | 7.7 | 9.98 | 0.178 | 1.78 | 315 | 0.65 |
| No. 11 | Comparative | Remainder | 3.5 | 4.5 | 8.4 | 9.56 | 0.214 | 2.05 | 328 | 0.57 |
| | Example | | | | | | | | | |
| No. 12 | Comparative | Remainder | 3.0 | 4.5 | 9.0 | 9.68 | 0.256 | 2.48 | 346 | 0.53 |
| | Example | | | | | | | | | |
| No. 13 | Comparative | Remainder | 3.5 | 5.5 | 10.0 | 8.56 | 0.312 | 2.67 | 355 | 0.48 |
| | Example | | | | | | | | | |

| | | Manufacturing condition of soft | | | | | | |
|---|---|---|---|---|---|---|---|---|
| | | magnetic powder | | | | | | |
| | | | Difference | | Evaluation of soft | | | |
| | | | between | Outer | magnetic powder | | | |
| | | | casting | diameter | | | Magnetic | |
| | | | temperature | of molten | Powder | Density | permeability | |
| | | Casting | and melting | metal | tap | of green | of green | |
| | | temperature | point | streamlet | density | compact | compact | |
| Sample No. | | ° C. | ° C. | mm | g/cm³ | g/cm³ | — | — |
| No. 1 | Comparative | 1900 | 410 | 1.0 | 4.88 | 6.44 | 34.7 | D |
| | Example | | | | | | | |
| No. 2 | Comparative | 1880 | 390 | 1.0 | 4.87 | 6.43 | 34.9 | D |
| | Example | | | | | | | |
| No. 3 | Comparative | 1850 | 360 | 1.0 | 4.86 | 6.42 | 35.3 | C |
| | Example | | | | | | | |
| No. 4 | Example | 1830 | 340 | 1.0 | 4.85 | 6.40 | 35.5 | B |
| No. 5 | Example | 1810 | 320 | 1.0 | 4.76 | 6.35 | 35.8 | B |
| No. 6 | Example | 1790 | 300 | 1.0 | 4.60 | 6.30 | 36.2 | A |
| No. 7 | Example | 1780 | 290 | 1.0 | 4.45 | 6.25 | 36.4 | A |
| No. 8 | Example | 1750 | 260 | 1.0 | 4.39 | 6.20 | 36.6 | A |
| No. 9 | Example | 1720 | 230 | 1.0 | 4.22 | 6.15 | 36.0 | A |
| No. 10 | Example | 1700 | 210 | 1.0 | 4.10 | 6.09 | 35.7 | B |
| No. 11 | Comparative | 1680 | 190 | 1.0 | 4.05 | 6.05 | 35.2 | D |
| | Example | | | | | | | |
| No. 12 | Comparative | 1660 | 170 | 1.0 | 4.02 | 6.00 | 34.5 | D |
| | Example | | | | | | | |
| No. 13 | Comparative | 1640 | 150 | 1.0 | 3.99 | 5.96 | 34.5 | D |
| | Example | | | | | | | |

TABLE 2

| | | Configuration of soft magnetic powder | | | | | | | | | |
|---|---|---|---|---|---|---|---|---|---|---|---|
| | | | | | | | Average | | | | |
| | | | | | | | particle | Oxygen | | | |
| | | Composition | | | | | diameter | content | α × | Vickers | Average |
| | | Fe | Si | Cr | C | A/B | α | β | β | hardness | circularity |
| Sample No. | | Mass % | | | | — | μm | Mass % | — | — | — |
| No. 14 | Example | Remainder | 2.5 | 4.5 | | 4.0 | 9.87 | 0.108 | 1.07 | 218 | 0.85 |
| No. 15 | Example | Remainder | 5.0 | 4.5 | | 4.5 | 9.58 | 0.120 | 1.15 | 230 | 0.82 |
| No. 16 | Example | Remainder | 3.5 | 3.0 | | 4.0 | 10.56 | 0.110 | 1.16 | 220 | 0.84 |
| No. 17 | Example | Remainder | 3.5 | 6.0 | | 4.5 | 10.60 | 0.122 | 1.29 | 233 | 0.81 |
| No. 18 | Example | Remainder | 3.5 | 4.5 | 0.0050 | 4.2 | 10.40 | 0.110 | 1.14 | 219 | 0.85 |
| No. 19 | Example | Remainder | 3.5 | 4.5 | 0.0100 | 4.2 | 10.25 | 0.108 | 1.11 | 218 | 0.86 |
| No. 20 | Example | Remainder | 3.5 | 4.5 | 0.0200 | 4.3 | 9.74 | 0.107 | 1.04 | 217 | 0.86 |
| No. 21 | Example | Remainder | 3.5 | 4.5 | | 4.2 | 16.80 | 0.095 | 1.60 | 201 | 0.83 |
| No. 22 | Example | Remainder | 3.5 | 4.5 | | 4.1 | 4.87 | 0.250 | 1.22 | 234 | 0.68 |
| No. 23 | Comparative | Remainder | 2.5 | 3.0 | | 2.1 | 10.40 | 0.300 | 3.12 | 135 | 0.65 |
| | Example | | | | | | | | | | |
| No. 24 | Comparative | Remainder | 4.5 | 5.5 | | 7.8 | 9.87 | 0.450 | 4.44 | 377 | 0.62 |
| | Example | | | | | | | | | | |

| | | Manufacturing condition of soft | | | | | | |
|---|---|---|---|---|---|---|---|---|
| | | magnetic powder | | | | | | |
| | | | Difference | | Evaluation of soft magnetic | | | |
| | | | between | Outer | magnetic powder | | | |
| | | | casting | diameter | | Density | Magnetic | |
| | | | temperature | of molten | Powder | of | permeability | |
| | | Casting | and melting | metal | tap | green | of green | |
| | | temperature | point | streamlet | density | compact | compact | |
| Sample No. | | ° C. | ° C. | mm | g/cm³ | g/cm³ | — | — |
| No. 14 | Example | 1800 | 310 | 1.0 | 4.62 | 6.31 | 35.8 | B |
| No. 15 | Example | 1790 | 300 | 1.0 | 4.60 | 6.28 | 36.0 | A |
| No. 16 | Example | 1790 | 300 | 1.0 | 4.58 | 6.30 | 35.9 | B |
| No. 17 | Example | 1780 | 290 | 1.0 | 4.57 | 6.29 | 36.0 | A |
| No. 18 | Example | 1780 | 290 | 1.0 | 4.62 | 6.32 | 36.3 | A |
| No. 19 | Example | 1780 | 290 | 1.0 | 4.64 | 6.34 | 36.5 | A |
| No. 20 | Example | 1780 | 290 | 1.0 | 4.65 | 6.34 | 36.4 | A |
| No. 21 | Example | 1790 | 300 | 1.5 | 4.59 | 6.29 | 35.8 | B |
| No. 22 | Example | 1790 | 300 | 0.5 | 4.14 | 6.10 | 35.3 | C |
| No. 23 | Comparative | 1810 | 320 | 1.0 | 4.02 | 6.00 | 34.4 | D |
| | Example | | | | | | | |
| No. 24 | Comparative | 1710 | 220 | 1.0 | 3.98 | 5.95 | 34.5 | D |
| | Example | | | | | | | |

As illustrated in Table 1 and Table 2, in the soft magnetic powder of each example, both the value of A/B and the Vickers hardness fall within predetermined ranges. Therefore, it was confirmed that the soft magnetic powder of each example features high tap density and high fluidity. In addition, it was confirmed that the green compact manufacturing using the soft magnetic powder of each example features high density and high magnetic permeability.

It was also recognized that the soft magnetic powder of each example features high average circularity of particles.

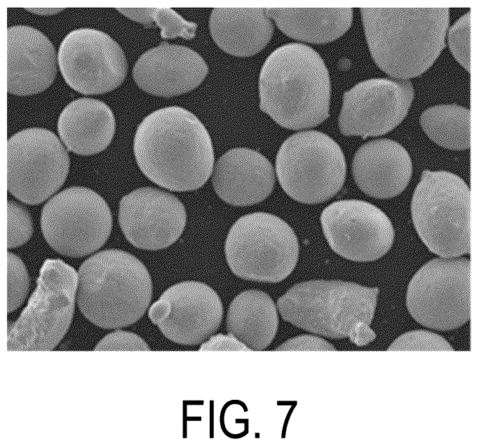

FIG. 6 is an electron micrograph taken of soft magnetic powder that is Sample No. 13 as Comparative Example. FIG. 7 is an electron micrograph of soft magnetic powder that is Sample No. 6 an Example.

As illustrated in FIG. 6, regarding the soft magnetic powder of Sample No. 13, irregularities are observed on the surface of the particles, and it is found that the circularity is low. On the other hand, in FIG. 7 illustrating the image of the soft magnetic powder of Sample No. 6, it is found that the surface of the particle is smooth and close to a circle. Such a difference in the circularity is expected to also affect the tap density of the powder and the density of the green compact described above.

What is claimed is:

1. A soft magnetic powder comprising:
Fe as a main component;
Si contained at 2.5 mass % to 7.5 mass %;
Cr contained at 1.0 mass % to 10.0 mass %; and
impurities, wherein
a Vickers hardness of a cross section of a particle is 150 or more and 350 or less, and
A/B is 2.0 or more and 8.0 or less, where A is a particle diameter [μm] as an equivalent circle diameter of the particle, and B is a crystal grain diameter [μm] as an equivalent circle diameter of a crystal included in the particle.

2. The soft magnetic powder according to claim 1 further comprising C contained at 0.0050 mass % to 0.0200 mass %.

3. The soft magnetic powder according to claim 1, wherein α×β is preferably 0.6 or more and 1.8 or less, where α is an average particle diameter and β is an oxygen content.

4. The soft magnetic powder according to claim 1, wherein an average circularity of the particle is 0.60 or more.

5. A dust core comprising the soft magnetic powder according to claim 1.

6. A magnetic element comprising the dust core according to claim 5.

7. An electronic device comprising the magnetic element according to claim 6.
